(19) United States
(12) Patent Application Publication
(10) Pub. No.: US 2020/0164631 A1
(43) Pub. Date: May 28, 2020

(54) INK SUPPLY DEVICE FOR PRINTER

(71) Applicant: I. MER CO., LTD., Kyoto-shi, Kyoto (JP)

(72) Inventor: Masayuki IZUME, Kyoto-shi (JP)

(73) Assignee: I. MER Co., Ltd., Kyoto-shi, Kyoto (JP)

(21) Appl. No.: 16/311,683

(22) PCT Filed: Jun. 15, 2017
(86) PCT No.: PCT/JP2017/022061

§ 371 Date: Dec. 20, 2018

(30) Foreign Application Priority Data
Jun. 23, 2016 (JP) 2016-124080

(51) Int. Cl. B41F 35/04; B41F 31/10; B41F 31/20

(52) U.S. Cl. CPC B41F 35/04; B41F 31/20; B41F 31/10

(57) ABSTRACT

Provided is an ink supply device for a printer, which does not require cleaning process by manual work, even in the case where ink remains in gap portions between adjacent divided ink ductor rollers. A divided ink ductor roller cleaning unit 7 is provided, which includes a cleaning roller 21 having an outer periphery covered with a cleaning fabric 26 and having an axis parallel to an axis of a plurality of divided ink ductor rollers 4. The cleaning roller 21 is pressed against the plurality of divided ink ductor rollers 4, and the cleaning fabric 26 enters gap portions between the adjacent divided ink ductor rollers 4, whereby the divided ink ductor roller cleaning unit 7 wipes off ink adhering to outer peripheral portions of end faces of the divided ink ductor rollers 4.

### TECHNICAL FIELD

The present invention relates to an ink supply device for a printer, the ink supply device including a plurality of divided ink ductor rollers that are controlled individually.

### BACKGROUND ART

As an ink supply device for a printer, a configuration is known such that: a plurality of divided ink ductor rollers that are divided in a longitudinal direction of an ink fountain roller constituting an ink fountain are arranged in close proximity to the ink fountain roller; and each of the divided ink ductor rollers is individually switched between a contact position to be in contact with the ink fountain roller and a non-contact position to be away from the ink fountain roller (Patent Literature 1).

When a setup change is executed in a printer, cleaning of the ink supply device is required. Patent Literature 1 discloses conducting an automatic cleaning of the rollers for the ink supply device by performing both of scraping with a cleaning blade and of cleaning with a cleansing liquid.

### CITATION LIST

### Patent Literature

Patent Literature 1: Japanese Unexamined Patent Application Publication No. JP-A-2006-272749

### SUMMARY OF INVENTION

### Technical Problem

Regarding the cleaning of the rollers of the ink supply device for a printer as disclosed by Patent Literature 1, there has been a problem that a plurality of divided ink ductor rollers additionally require cleaning by manual work, because ink remains in gap portions between the adjacent divided ink ductor rollers after the automatic cleaning, in some cases.

An object of the present invention is to provide an ink supply device for a printer, which does not require cleaning process by manual work, even in the case where ink remains in gap portions between adjacent divided ink ductor rollers.

### Solution to Problem

The ink supply device for a printer in accordance with the present invention is an ink supply device for a printer, the ink supply device being configured such that: a plurality of divided ink ductor rollers that are divided in a longitudinal direction of an ink fountain roller constituting an ink fountain are arranged in close proximity to the ink fountain roller; and each of the divided ink ductor rollers is individually switched between a contact position to be in contact with the ink fountain roller and a non-contact position to be away from the ink fountain roller, wherein the ink supply device is provided with a divided ink ductor roller cleaning unit that includes a cleaning roller having an outer periphery covered with a cleaning fabric and having an axis parallel to an axis of the plurality of divided ink ductor rollers, and the cleaning roller is pressed against the plurality of divided ink ductor rollers, and the cleaning fabric enters gap portions between the adjacent divided ink ductor rollers, whereby the divided ink ductor roller cleaning unit wipes off ink adhering to outer peripheral portions of end faces of the divided ink ductor rollers.

The cleaning roller may be pressed against the plurality of divided ink ductor rollers by its own weight or by a pressing device. In either of the cases, any appropriate movement mechanism may be used to cause the cleaning roller to be held at a standby position to be away from the plurality of divided ink ductor rollers at the time of printing, and to cause the cleaning roller to be moved to an operating position to press against the plurality of divided ink ductor rollers at the time of cleaning.

With the ink supply device for a printer in accordance with the present invention, because the divided ink ductor roller cleaning unit is provided, it becomes possible to perform an automatic cleaning of ink adhering to end faces of the plurality of divided ink ductor rollers, which has been difficult without the divided ink ductor roller cleaning unit.

Other conceivable cleaning units to be provided include, for example, an ink fountain roller cleaning unit, an ink distributor roller cleaning unit, etc. It is preferable that the ink fountain roller cleaning unit and the ink distributor roller cleaning unit each include an ink scraping blade.

In some cases, the divided ink ductor roller cleaning unit includes: a first movement mechanism configured to support opposite end portions of the cleaning roller and move the cleaning roller between a standby position to be away from the plurality of divided ink ductor rollers and an operating position to press against the plurality of divided ink ductor rollers; and a second movement mechanism configured to move the cleaning roller in an axial direction thereof.

Because the second movement mechanism configured to move the cleaning roller in the axial direction is provided, moving the cleaning roller in the axial direction during the cleaning process allows enhanced cleaning action, and moving the cleaning roller in the axial direction after the cleaning process allows cleaning utilizing the entire range of the cleaning roller, whereby the frequency of replacement of the cleaning fabric is decreased.

For example, the second movement mechanism may be configured to rotate a circular cam about an eccentric position by a motor, or may be configured to use a ball screw or a feed screw.

### Advantageous Effects of Invention

With the ink supply device for a printer in accordance with the present invention, because the divided ink ductor roller cleaning unit is provided which includes a cleaning roller having an outer periphery covered with a cleaning fabric and having an axis parallel to an axis of the plurality of divided ink ductor rollers, it becomes possible to perform an automatic cleaning of ink adhering to end faces of the plurality of divided ink ductor rollers, which has been difficult without the divided ink ductor roller cleaning unit, whereby the cleaning operation is readily performed.

### BRIEF DESCRIPTION OF DRAWINGS

FIG. 1 is a perspective view of an ink supply device for a printer in accordance with a first embodiment of the present invention.

FIG. 2 is a cross-sectional view of a cleaning roller.

FIG. 3 is an enlarged cross-sectional view of the cleaning roller at the time of cleaning.

### REFERENCE SIGNS LIST

1: ink supply device for printer
2: ink fountain
3: ink fountain roller
4: divided ink ductor roller
7: divided ink ductor roller cleaning unit
21: cleaning roller
23: fluid pressure cylinder (first movement mechanism)
26: cleaning fabric
28: cam mechanism (second movement mechanism)

### DESCRIPTION OF EMBODIMENTS

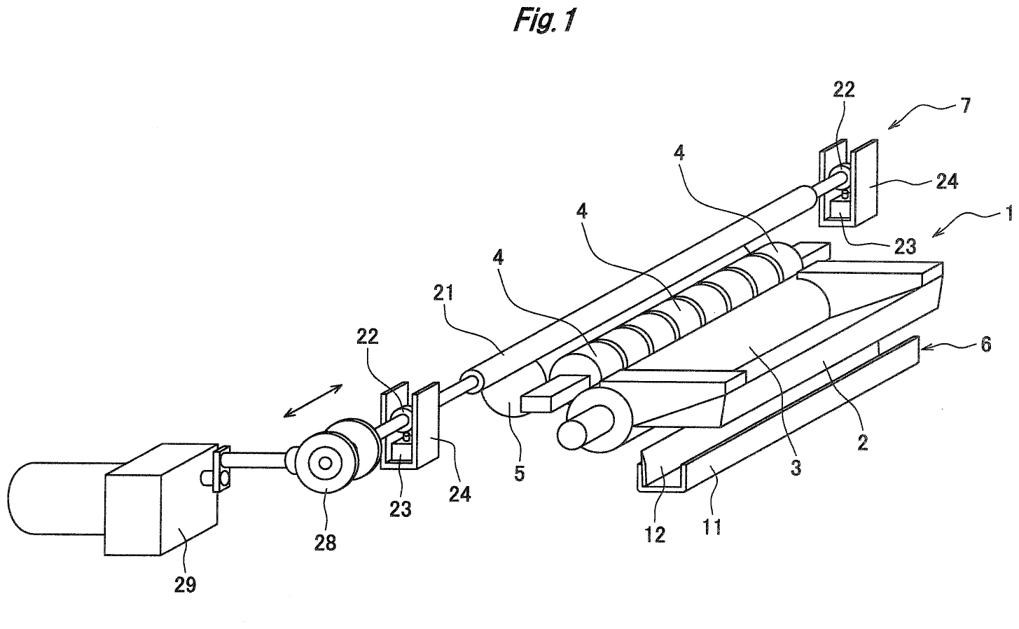

A first embodiment of the present invention will be described below with reference to FIG. 1 to FIG.

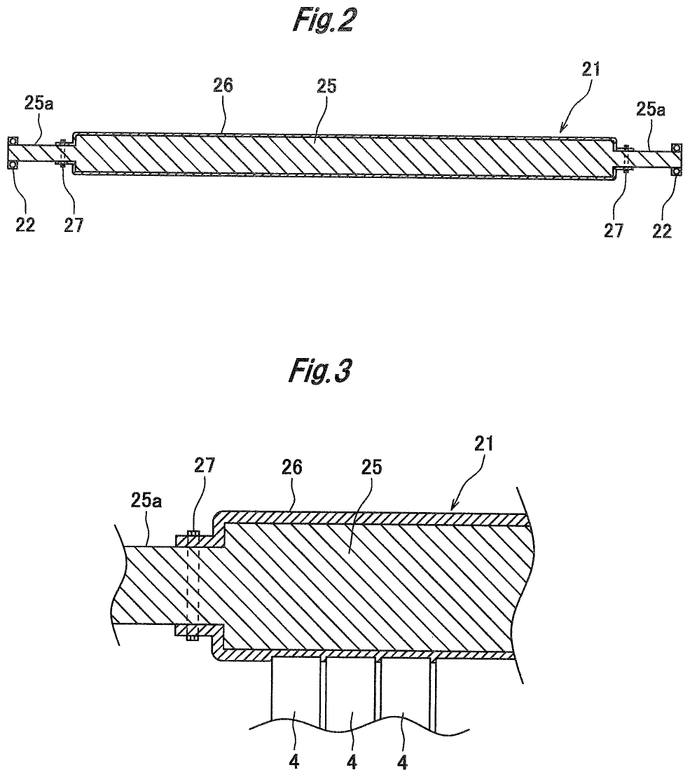

3. In the following description, the left side and the right side of FIG. 2 are referred to as “left” and “right”, respectively.

As shown in FIG. 1, an ink supply device 1 for a printer includes: an ink fountain 2; an ink fountain roller 3; a plurality of divided ink ductor rollers 4 that are divided in a longitudinal direction of the ink fountain roller 3; a plurality of ink distributor rollers 5 (one ink distributor roller 5 is shown in FIG. 1); an ink fountain roller cleaning unit 6; and a divided ink ductor roller cleaning unit 7.

The ink supply device 1 is configured such that: each of the divided ink ductor rollers 4 is individually switched between a contact position to be in contact with the ink fountain roller 3 and a non-contact position to be away from the ink fountain roller 3; and a controller controls a circumferential length of each of the divided ink ductor rollers 4 along which ink is to be transferred from the ink fountain roller 3 to the divided ink ductor rollers 4. This control is achieved: by switching the position of a divided ink ductor roller 4 that is required so as to be in contact with ink at a timing with a specified interval; and by controlling a rotation angle of the ink fountain roller 3 from a point where the divided ink ductor roller 4 comes into contact with the ink fountain roller 3 to a point where the divided ink ductor roller 4 moves away from the ink fountain roller 3, for each of the divided ink ductor rollers 4.

Ink that has been supplied to the divided ink ductor rollers 4 is transferred to the ink distributor roller 5 to be transferred in turn to a plate cylinder by a plurality of rollers not shown.

The divided ink ductor rollers 4 and the controller therefor are known ones, the detailed description of which is therefore not given.

The ink fountain 2 is provided with, as an ink fountain cleaning unit, a cover film (not shown) so as to cover the ink fountain 2 in a state of not being supplied with ink. At the time of a setup change, this cover film is wound up automatically by a motor being driven, whereby ink is eliminated from the ink fountain 2.

The ink fountain roller cleaning unit 6 includes: a waste ink collector tank 11 that is movable relative to the ink fountain roller 3 and is moved between a standby position and an ink scraping position; and a blade 12 that is provided to the waste ink collector tank 11 and is capable of scraping ink adhering to the ink fountain roller 3. Although not shown, the ink fountain roller cleaning unit 6 includes a nozzle to spray a cleansing liquid, in some cases.

A cleaning unit similar to the ink fountain roller cleaning unit 6 is also provided to the ink distributor rollers that are required but not shown.

The divided ink ductor roller cleaning unit 7 includes: a long cleaning roller 21 that has an axis parallel to an axis of the plurality of divided ink ductor rollers and is movable in the axial direction; left and right bearings 22 that support opposite end portions of the cleaning roller 21 in a rotatable manner; left and right fluid pressure cylinders 23 that support the bearings 22 and are vertically movable; and left and right casings 24 that accommodate the left and right bearings 22 and the left and right fluid pressure cylinders 23, respectively.

As shown in FIG. 2, the cleaning roller 21 includes: a solid roller 25 made of metal; and a cleaning fabric 26 formed into a circular tube shape and covered on the solid roller 25 in a replaceable manner. The solid roller 25 includes opposite end portions 25a each having a small diameter. The cleaning fabric 26 includes opposite end portions that are fixed to the corresponding opposite end portions 25a of the solid roller 25 with fixing bands 27.

The cleaning roller 21 is provided at one end portion thereof with a cam mechanism 28 that is configured to move the cleaning roller 21 in the axial direction. The cam mechanism 28 has a cam that is rotated by a motor 29, which results in the movement of the cleaning roller 21 in the axial direction. The maximum movement amount of the cleaning roller 21 in the axial direction is approximately equal to the dimension of the divided ink ductor roller 4 in the axial direction.

The left and right fluid pressure cylinders 23 are brought into an ON state whereby the cleaning roller 21 is held by the left and right fluid pressure cylinder 23 at a position away from the divided ink ductor rollers 4, whereas the left and right fluid pressure cylinders 23 are brought into an OFF state whereby the cleaning roller 21 is pressed against the divided ink ductor rollers 4 by its own weight.

When the cleaning roller 21 is pressed against the divided ink ductor rollers 4 by its own weight, the cleaning fabric 26 of the cleaning roller 21 enters gaps between the adjacent divided ink ductor rollers 4, as shown in FIG. 3. In this state, the divided ink ductor rollers 4 are rotated, whereby ink adhering to the end faces of the divided ink ductor rollers 4 is wiped off.

For example, the cleaning fabric 26 is composed of a cellulose fiber. However, any fabric composed of various fibers and any nonwoven fabric may be used for the cleaning fabric 26 as long as they have cushioning properties such that they enter the gaps between the adjacent divided ink ductor rollers 4.

The cleaning of the ink supply device 1 of a printer in accordance with this embodiment is performed by the following procedure, i.e., in the order of the cleaning of the ink fountain 2, the cleaning by the ink fountain roller cleaning unit 6, and then the cleaning by the divided ink ductor roller cleaning unit 7.

As described above, the cleaning of the ink fountain 2 is performed by the cover film being wound up. At this time, ink that remains in the ink fountain 2 is caused to be exposed to the outer peripheral surface of the ink fountain roller 3, and in this state the ink fountain roller 3 is rotated while the blade 12 of the ink fountain roller cleaning unit 6 is pressed against the outer peripheral surface of the ink fountain roller 3, whereby ink is scraped off by the blade 12 to be collected into the waste ink collector tank 11.

The ink that has been transferred to the divided ink ductor rollers 4 is transferred to the ink distributor roller 5 and other rollers by the rotation of the ink distributor roller 5, and thus the amount of ink remaining on the outer peripheral surfaces of the divided ink ductor rollers 4 and the ink distributor roller 5 is decreased. The divided ink ductor rollers 4, the ink distributor roller 5, and other rollers are automatically cleaned using a cleansing liquid in the same manner as in the conventional case. At this time, the cleansing liquid for the automatic cleaning may be transferred from the ink distributor roller 5 side to the ink fountain roller 3 by switching the position of the divided ink ductor rollers 4, if required.

Here, regarding the plurality of divided ink ductor rollers 4, because the gaps are provided between the adjacent divided ink ductor rollers 4, there is a possibility that ink adheres to the end faces of the divided ink ductor rollers 4 and such ink adhering thereto cannot be cleaned off from the end faces by the above-described cleaning process.

However, because the ink supply device 1 in accordance with the above-described embodiment includes the divided ink ductor roller cleaning unit 7, it is possible to clean the end faces of the divided ink ductor rollers 4 using the divided ink ductor roller cleaning unit 7 at the final stage of the cleaning process. This does not require cleaning by manual work, even in the case where ink remains in the gap portions between the adjacent divided ink ductor rollers, whereby the cleaning operation is readily performed.

### INDUSTRIAL APPLICABILITY

Cleaning the rollers of the ink supply device for a printer does not require manual work, which contributes to improvement of the performance of the printer.

1. An ink supply device for a printer, the ink supply device being configured such that: a plurality of divided ink ductor rollers that are divided in a longitudinal direction of an ink fountain roller constituting an ink fountain are arranged in close proximity to the ink fountain roller; and each of the divided ink ductor rollers is individually switched between a contact position to be in contact with the ink fountain roller and a non-contact position to be away from the ink fountain roller, wherein
the ink supply device is provided with a divided ink ductor roller cleaning unit that includes a cleaning roller having an outer periphery covered with a cleaning fabric and having an axis parallel to an axis of the plurality of divided ink ductor rollers, and
the cleaning roller is pressed against the plurality of divided ink ductor rollers, and the cleaning fabric enters gap portions between the adjacent divided ink ductor rollers, whereby the divided ink ductor roller cleaning unit wipes off ink adhering to outer peripheral portions of end faces of the divided ink ductor rollers.

2. The ink supply device according to claim 1, wherein the divided ink ductor roller cleaning unit comprises:
a first movement mechanism configured to support opposite end portions of the cleaning roller and move the cleaning roller between a standby position to be away from the plurality of divided ink ductor rollers and an operating position to press against the plurality of divided ink ductor rollers; and
a second movement mechanism configured to move the cleaning roller in an axial direction thereof.
